(19) United States
(12) Patent Application Publication
(10) Pub. No.: US 2020/0009000 A1
(43) Pub. Date: Jan. 9, 2020

(54) SYSTEMS, METHODS, AND TABLES FOR CATHETER-BASED VASCULAR PROCEDURES

(71) Applicant: TAYAL WASTY APPROACH LLC, Basking Ridge, NJ (US)

(72) Inventors: NAJAM WASTY, Basking Ridge, NJ (US); RAJ TAYAL, Warren, NJ (US)

(73) Assignee: TAYAL WASTY APPROACH LLC, Basking Ridge, NJ (US)

(21) Appl. No.: 16/503,680

(22) Filed: Jul. 5, 2019

Related U.S. Application Data
(60) Provisional application No. 62/694,631, filed on Jul. 6, 2018.

(51) Int. Cl. A61G 13/12

(52) U.S. Cl. CPC A61G 13/1235; A61G 2200/32; A61G 13/1295; A61G 13/126

(57) ABSTRACT

An auxiliary table adapted to be placed at right angle to a catherization table near the top end of the catherization table where a patient's head lies so as to allow for full-out extension of the patient's left arm on the auxiliary table. The auxiliary table is hingedly secured to said catherization table. The auxiliary table comprises vertical lead screens and vertical lead blinds placed above and below the auxiliary table about 2/7 of the way into the auxiliary table away from the catherization table. The auxiliary table is on wheels. The auxiliary table comprises a tabletop and a storage shelf below the tabletop. Systems and methods of using the disclosed auxiliary table.

### TECHNICAL FIELD

This disclosure relates to the field of catheter-based vascular procedures. More specifically, this disclosure provides systems, methods, and tables auxiliary to the catherization table for performing catheter-based vascular procedures.

### BACKGROUND

During lengthy catheter-based vascular procedures, operators are exposed to excessive radiation and suffer fatigue as they stand with heavy protective lead apron for the duration of the procedure. Increased risk of exposure related illnesses in such operators have now been well documented as has been the damaging effect of long hours of standing on operator musculoskeletal system.

### SUMMARY

This disclosure provides an auxiliary table for use in a catheter-based vascular procedure;
wherein said auxiliary table is adapted to be placed at right angle to a catherization table near the top of the catherization table where a patient's head lies during said procedure, allowing for full-out extension of the patient's abducted left arm on the auxiliary table;
said auxiliary table has four sides: a left side that is to be placed next to the catherization table, a right side, a front and a back;
said auxiliary table comprises hinges on the left side of said auxiliary table that allow the left side of the auxiliary table to be hingedly secured to said catherization table;
said auxiliary table comprises vertical lead screen and flexible vertical lead blinds placed above and below the auxiliary table about 2/7 of the way into the auxiliary table from the left side of the auxiliary table and extending out of the front of the auxiliary table;
wherein said vertical lead screen is made of transparent lead plexiglass;
wherein said vertical lead screen has two panels: a first panel of the vertical lead screen placed above the auxiliary table and a second panel of the vertical lead screen that extends out of the front of the auxiliary table;
wherein a hinge is placed between the two panels of the vertical lead screen to allow the second panel to fold and to swing;
wherein the first panel has in its center bottom a cutout that is an about 6 inch to about 6.5 inch semicircle;
wherein a rod is placed vertically in the first panel of the vertical lead screen at the back of the auxiliary table; wherein the hinge and the rod allow the panels of the vertical lead screen to be lifted and folded down flat for storage;
wherein said flexible vertical lead blinds are placed below the two panels of vertical lead screen;
wherein the flexible vertical lead blinds are vertical flexible opaque lead leaves, each leaf about 4-6 inches wide (or may be 3-5 inches wide);
wherein the flexible vertical lead blinds are two panels, each panel having a number of leaves; wherein a first panel of blinds is placed below the first panel of lead screen and a second panel of blinds is placed below the second panel of lead screen;
wherein a hinge is located between the two panels of blinds, allowing the two panels of blinds to fold and to swing;
wherein on the right side of the auxiliary table, lead counter weight equal in weight to the weight of the vertical lead screen and vertical lead blinds combined is placed (in certain embodiments, the lead counterweight is placed just below the tabletop on the right end of the auxiliary table);
said auxiliary table comprises a rod or a fixed T-shaped rail that runs along the length of the back of the auxiliary table;
wherein an IV fluid pole is latched onto the rod or fixed T-shaped rail;
said auxiliary table comprises wheels;
said auxiliary table comprises a tabletop and a storage shelf below the tabletop;
wherein the tabletop is at the top of the table and runs the length and the width of the table and the storage shelf is placed below the tabletop and above the floor by about 12 inches; but it does not run the full length or width of the table;
wherein the storage shelf is recessed with respect to the front of the auxiliary table, so as to allow a user to put his legs underneath the auxiliary table when the auxiliary table is used in a procedure and the user is seated at a stool in front of the auxiliary table;
wherein the storage shelf only extends in length to where the vertical lead blinds and lead screens are placed;
wherein auxiliary table comprises 4 legs: the two legs on the right side being placed just beneath the end of the right side of the auxiliary table; the two legs on the left side are placed just to the right of the lead screens and lead blinds—they are not placed on the left end of the table, but are placed about 2 feet to the right of the left end of the auxiliary table.

In certain embodiments, the auxiliary table of claim 1, wherein the rod or the fixed T-shaped rail is a grooved T-shaped rail about 1″ to about 2″ thick running along the entire length of the back of the auxiliary table; wherein the T-shaped rail is a total of about 2-3 inches in width, with two about 1 to about 1.5 inches sections—a section that is the vertical part of the T and a section that is the horizontal line of the T.

In certain embodiments, the tabletop is further covered by rubberized material.

This disclosure also provides a system for performing a catheter-based vascular procedure, comprising: a disclosed auxiliary table and a catherization table. The auxiliary table is placed at right angle to a catherization table near the top of the catherization table where the patient's head lies so as to allow for full-out extension of the patient's abducted left arm on the auxiliary table. The auxiliary table may be hingedly connected to the catherization table.

In certain embodiments, the system further comprising a stool for the operator to sit on, and in certain embodiments the stool being placed in front of the auxiliary table.

This disclosure also provides a method for performing a catheter based vascular procedure, comprising: placing a patient's abducted left arm in a full-out extension on a disclosed auxiliary table placed at right angle to a catherization table, near the top of the catherization table where the patient's head lies; wherein said auxiliary table is hingedly secured to said catherization table; wherein placement of all control panels being on the left side of the catherization table in easy reach of an operator's left hand; having an operator perform the catheter based vascular procedure.

Numerous other aspects and embodiments are provided in accordance with these and other aspects of the invention. Other features and aspects of the present invention will become more fully apparent from the following detailed description and the appended claims.

### BRIEF DESCRIPTION OF THE DRAWINGS

FIG. 1 shows a view of an embodiment of a disclosed auxiliary table from the operator's point of view.

FIG. 2 shows a view of an embodiment of a disclosed auxiliary table from the opposite side of the operator.

FIG. 3 shows an embodiment of a grooved T shaped rail running along the entire length of the back of the auxiliary table.

### DETAILED DESCRIPTION

As used herein, the word “a” or “plurality” before a noun represents one or more of the noun.

As used herein, the terms “subject” and “patient” are used interchangeably. A patient or a subject can be a human patient or a human subject.

For the terms “for example” and “such as,” and grammatical equivalences thereof, the phrase “and without limitation” is understood to follow unless explicitly stated otherwise. As used herein, the term “about” is meant to account for variations due to experimental error. All measurements reported herein are understood to be modified by the term “about,” whether the term is explicitly used, unless explicitly stated otherwise. As used herein, the singular forms “a,” “an,” and “the” include plural referents unless the context clearly dictates otherwise.

Unless otherwise defined, all technical and scientific terms used herein have the same meaning as commonly understood by one of ordinary skill in the art to which this invention belongs. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

During lengthy catheter-based vascular procedures (including, without limitation, cardiac catherization), operators (including, without limitation, doctors, nurses, etc.) are exposed to excessive radiation and suffer fatigue as they stand with heavy protective lead apron for the duration of the procedure. Increased risk of exposure related illnesses in such operators have now been well documented as has been the damaging effect of long hours of standing on operator musculoskeletal system.

Radiation exposure is proportionally related to the distance from the source of radiation. Thus, by abducting the patients arm at 90 degrees and resting this arm on a suitably designed table (the disclosed auxiliary table) the radiation exposure can be reduced several folds. The operator can perform the procedure 3-5 feet further away (or more) from the source of the radiation. And the operator does not need to wear a heavy protective lead apron. Moreover, when the operator moves a few feet away from the catheterization table it becomes very easy for the operator to sit down on a stool and perform the procedure sitting down, thereby minimizing fatigue and potentially enhancing operator performance. The operator's long term bodily wear and tear should thus be minimized.

There is currently no table on the market that fulfills the specifications required to latch on at right angle to the catheterization table without impeding the rotation of the image intensifier around the patient and with protective lead shields built into the design of the table, further minimizing radiation exposure to the operator.

This disclosure provides such a table for use during catheter based vascular procedures, whether they are on the heart, the brain, the abdominal vasculature or the lower extremity vasculature. This table moves seamlessly with the catheterization table without posing hindrance to rotation around the patient of the image intensifier. This table allows the operator to sit down on a stool 3-5 feet, or more, away from the source of radiation reducing operator radiation exposure markedly. Additionally, this table has built in above and below table level lead shields, further reducing the radiation exposure to operator.

As such the disclosed table delivers what the recently developed coronary and the peripheral robot attempts to deliver but at a fraction of the cost of the robot and without taking away the tactile feedback from the operator which is inherent to the robot. This table is thus named the poor man's robot.

This disclosure provides an auxiliary table (auxiliary to the catherization table) adapted to be placed at right angle to a catheterization table near the top end of the catheterization table where a patient's head lies (head side of the catherization table) so as to allow for full-out extension of the patient's abducted left arm on the auxiliary table. When in use in a procedure, the left side of the auxiliary table is hingedly secured to the catherization table (in some embodiments, using two hinges on the left side of the auxiliary table). When in use in a procedure, the back of the auxiliary table is behind the patient's head. When in use in a procedure, the right side of the auxiliary table is further away from the patient's body than the left side. The auxiliary table is on wheels (for example, 4 wheels), allowing the auxiliary table to move with the catherization table when the two are hingedly connected. The auxiliary table comprises 4 legs; the two legs on the right side are placed just beneath the end of the right side of the auxiliary table; whereas the two legs on the left side are placed just to the right of the lead screens and lead blinds
they are not placed on the left end of the table.

The auxiliary table comprises a tabletop and a storage shelf below the tabletop but above the floor. The tabletop is at the top of the table and runs the length and the width of the table. The storage shelf is placed below the tabletop and above the floor (in certain embodiments, by about 12 inches); but it does not run the full length or width of the table. In certain embodiments, the storage shelf is recessed with respect to the front of the auxiliary table, so as to allow a user to put his legs underneath the auxiliary table when the auxiliary table is used in a procedure and the user is seated at a stool in front of the auxiliary table. The storage shelf only extends in length to where the vertical lead blinds and lead screens are placed. In certain embodiments, the auxiliary table is rectangular. In certain embodiments, the auxiliary table is made of stainless steel.

The auxiliary table comprises vertical lead screen and vertical lead blinds placed on and below the auxiliary table about 2/7 of the way into the auxiliary table (they may be placed at other suitable distances) away from the catherization table (on the left side of the auxiliary table), as well as extending out of the front of the auxiliary table. The screens and the blinds are about 2 feet to the right of the left side of the auxiliary table. On the right side of the auxiliary table, lead counter weight is placed. The lead counter weight is equal in weight to the weight of the vertical lead screen and vertical lead blinds. In certain embodiments, the lead counterweight is placed just below the tabletop on the right end of the auxiliary table. The counter weight may be made of material other than lead.

The vertical lead screen is made of transparent lead plexiglass. The vertical lead screen is foldable, swingable, and liftable. There are two panels of the vertical lead screen: a first panel placed above the table and a second panel that extends beyond the front of the table towards the foot end of the catheterization table (i.e., the end where during a procedure a patient's feet would rest). A hinge between the two panels allow the second panel to fold onto the first panel (i.e., foldable) in either direction (side to side). Once folded, the two panels may be further folded downward to lay flat on the tabletop, allowing for easy storage. The second panel can also be swung, side to side, as it is hingedly attached to the first panel. The bottom of the first panel (the side that touches the auxiliary table) is made of any suitable material and of any suitable shape. The first panel has in its center bottom a cutout (in some embodiments, the cutout is about 6 inch to about 6.5 inch semicircle). This cutout accommodates the patient's arm through the first panel when the auxiliary table is used in a procedure. Both panels can be lifted up, allowing the patient's arm to be placed on the auxiliary table when the auxiliary table is used in a procedure. In addition to a hinge between the two panels, a rod is placed vertically in the first panel at the back of the table. The hinge and the rod allow the panels to be lifted (in certain embodiments, by about 6 inches). Flexible vertical lead blinds are placed below the two panels of vertical lead screen. The blinds are composed pf vertical flexible opaque lead leaves (blinds), each leaf (blind) about 4-6 inches wide. There are also two panels of blinds, each has a number of blinds (or leaves; the term “blinds” and “leaves” are used interchangeably herein). In certain embodiments, each blind (or leaf) is about 4-6 inches wide. A first panel of blinds is placed below the first panel of lead screen and a second panel of blinds is placed below the second panel of screen. A hinge is placed between the two panels of blinds, allowing the two panels of blinds to fold and to swing. The vertical blinds may be folded for easy storage. The tabletop may be further covered by rubberized or other suitable materials.

A rod or a fixed T-shaped rail runs along the length of the back of the auxiliary table. An IV fluid pole, or other equipment, may be latched onto the rod or fixed T-shaped rail. The IV fluid pole may be about 3-4 feet above the table and may be a telescoping IV pole, with the ability to have its height adjusted. The rod or the fixed T-shaped rail may be made of any suitable material, such as steel.

In certain embodiments, the rod or the fixed T-shaped rail is a grooved T-shaped rail about 1″ to about 2″ thick running along the entire length of the back of the auxiliary table. The T-shaped rail is a total of 2-3″ in width, with two 1-1.5 inches sections—a section that is the vertical part of the T and a section that is the horizontal line of the T.

This disclosure also provides a system for performing a catheter-based vascular procedure, comprising: a disclosed auxiliary table placed at right angle to a catherization table near the top of the catherization table where the patient's head lies so as to allow for full-out extension of the patient's abducted left arm on the auxiliary table. The auxiliary table is hingedly connected to the catherization table. The catherization table allows a patient to lay on and to have a catheter-based vascular procedure performed on the patient. The auxiliary table is hingedly secured to the catherization table. The placement of all control panels is on the left side of the catherization table, in easy reach of an operator's left hand. In certain embodiments, the system further comprises a stool for the operator to sit on, which stool being placed in front of the front of the auxiliary table.

In other aspects, this disclosure provides a method for performing a catheter based vascular procedure, comprising: placing a patient on a catherization table; placing the patient's abducted left arm in a full-out extension on a disclosed auxiliary table placed at right angle to the catherization table near the top end of the catherization table where the patient's head lies. The auxiliary table is hingedly secured to the catherization table. The placement of all control panels is on the left side of the catherization table in easy reach of an operator's left hand. The method further comprises having an operator perform the catheter based vascular procedure. In certain embodiments, the method further comprises having a stool for the operator to sit on, which stool being placed in front of the auxiliary table. Other equipment(s) commonly used for a catheter-based vascular procedure may be used in the disclosed method. One catheter-based vascular procedure is cardiac catherization.

Any other needed or optional component of a particular catheter-based vascular procedure may be present.

The auxiliary table, and any part thereof, may be made of any suitable material and by methods known in the art. The catherization table is a standard catherization table currently in use for performing catheter-based vascular procedures. The IV pole is also standardly used in medicine. The stool may be any suitable stool. The auxiliary table, and any part thereof, may be of any suitable dimension.

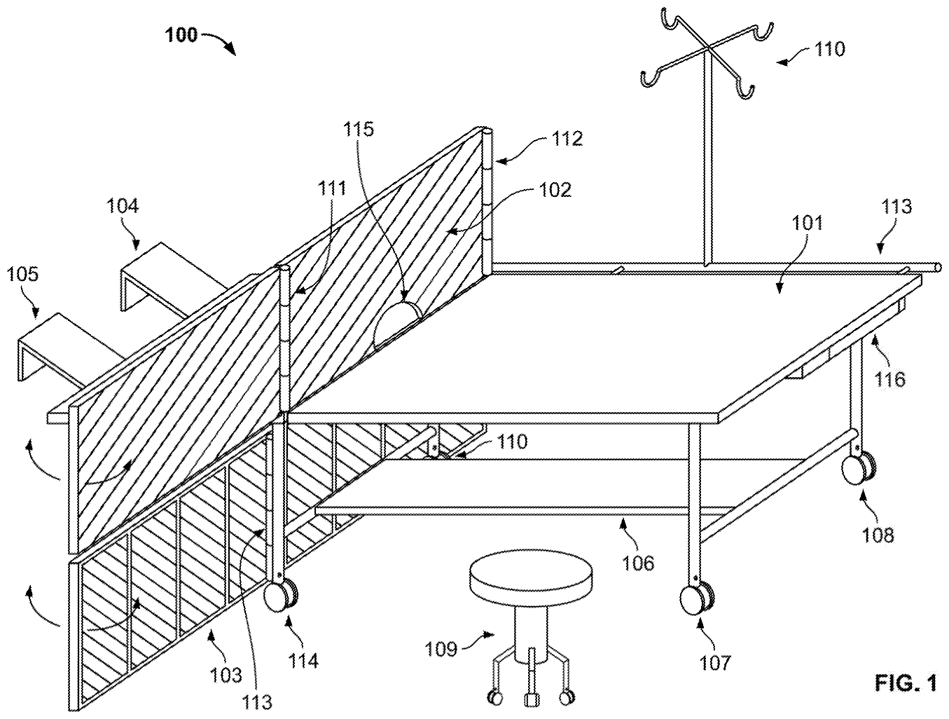

FIG. 1 shows a front view (view from the operator) of the disclosed system 100 with table 101 (made of stainless steel) that is auxiliary to a catherization table in a catheter-based vascular procedure. The auxiliary table may be of any length, height and width. Auxiliary table 101 is about 7 feet long, about 2.5 feet wide, and about 3 feet tall. A lead screen 102 (about 2 feet high and about 2.5 feet wide—i.e., the width of the table) with two panels and opaque vertical lead blinds 103 (about 2 feet high and about 2.5 feet wide—i.e., as wide as the lead screen) are vertically placed about 2 feet to the right of the catherization table (not shown), to the right of two hinged clasps 104 and 105 used to connect the auxiliary table 101 hingedly to the catherization table. Lead screen 102 and flexible vertical lead blinds 103 completely shield the operator sitting on the stool 109 or standing at or near the stool 109 from radiation. Lead screen 102 has two panels: a first panel sitting on top of the tabletop and a second panel extending in front of the auxiliary table 101. Flexible vertical lead blinds 103 also has two panels, a first panel of flexible vertical lead blinds 103 is just below the first panel of lead screen 102 and a second panel of flexible vertical lead blinds 103 is just below the second panel of flexible vertical lead blinds 103. Each leaf of the lead blinds is about 4-6 inches wide. The first panel of lead screen 102 has a semi-circle recess 115 in the center that is about six and a half inches in diameter, located where the first panel of lead screen 102 contacts the tabletop. A hinge 111 separates the two panels of lead screen 102 and the first panel of lead screen 102 has a rod 112 at its distal end at the back of the auxiliary table 101, allowing the two panels of lead screen 102 to fold and to swing. A hinge 113 also separates the two panels of flexible vertical lead blinds 103, allowing the two panels of flexible vertical lead blinds 103 to fold and/or to swing. The lead screen 102 and the lead blinds 103 can also be lifted and folded to rest on the table for storage. The lead blinds 103 can also swing. A lead counter weight 116 is placed just below the tabletop on the right side of the auxiliary table 101. The lead counter weight 116 is equal in weight to the total weight of the lead screen 102 and the lead blinds 103. The auxiliary table 101 has a steel storage shelf 106, which is about 5 feet long and 1 foot wide, below the tabletop of auxiliary table 101. The auxiliary table 101 has wheels 107, 108, 114, and 110. A stool 109 allows the operator to sit. An IV pole 110, about 1″ to 1.5″ in diameter, is attached to the auxiliary table 101 with a clasp onto a steel rail or rod 113 that run along the length of the auxiliary table 101. The IV pole 110 can be detached from the steel rail or rod 113 for storage. The auxiliary table comprises 4 legs; the two legs on the right side are placed just beneath the end of the right side of the auxiliary table; whereas the two legs on the left side are placed just to the right of the lead screens and lead blinds—they are not placed on the left end of the table, but are placed about 2 feet to the right of the left end of the table, so as to not offer an impediment for the C-arm with the camera to rotate (not shown). Each leg has a wheel at the bottom (114, 107, 108, 110). The distance between the front end of the vertical lead screen and the front of the table on the right side is about 5 feet.

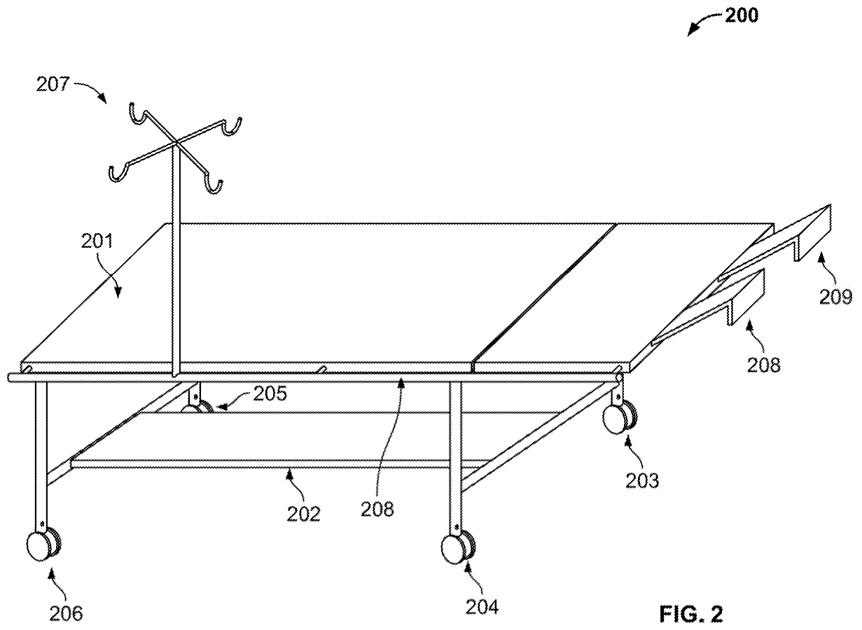

FIG. 2 shows the disclosed system 200 with disclosed auxiliary table 201 from a view opposite to where the operator sits. A table 201 (made of stainless steel) that is auxiliary to a catherization table in a catheter-based vascular procedure is shown. The auxiliary table may be of any length, height and width. Auxiliary table 201 is about 7 feet long, about 2.5 feet wide, and about 3 feet tall. The lead screen and lead blinds (opaque vertical lead leaves) are not shown. Two hinged clasps 208 and 209 are used to connect the auxiliary table 201 hingedly to the catherization table (not shown). The auxiliary table 201 has a steel storage shelf 202, which is about 5 feet long, below the tabletop of auxiliary table 201. The auxiliary table 201 has wheels 203, 204, 205, and 206. A stool (not shown) allows the operator to sit. An IV pole 207, about 1″ to 1.5″ in diameter, is attached to the auxiliary table 201 with a clasp onto a steel rail or rod 208 that run along the length of the auxiliary table 201. The IV pole 207 can be detached from the steel rail or rod 208 for storage.

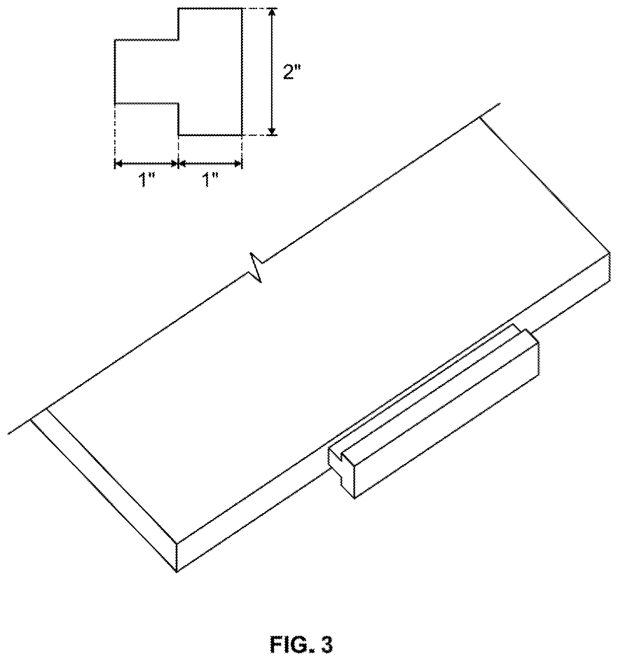

Instead of a rod as shown in FIG. 1 and FIG. 2, there can be a T-shaped rail. FIG. 3 shows a grooved T-shaped rail 2″ thick running along the entire length of the back of the auxiliary table. The T-shaped rail is a total of 2-3 inches in width, with 2.1-1.5 inches sections—a section that is the vertical part of the T and a section that is the horizontal line of the T.

OTHER EMBODIMENTS

The foregoing description discloses only exemplary embodiments of the invention.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the appended claims. Thus, while only certain features of the invention have been illustrated and described, many modifications and changes will occur to those skilled in the art. It is therefore to be understood that the appended claims are intended to cover all such modifications and changes as fall within the true spirit of the invention.

1. An auxiliary table for use in a catheter-based vascular procedure;
wherein said auxiliary table is adapted to be placed at right angle to a catherization table near the top of the catherization table where a patient's head lies during said procedure, allowing for full-out extension of the patient's abducted left arm on the auxiliary table;
said auxiliary table has four sides: a left side that is to be placed next to the catherization table, a right side, a front and a back;
said auxiliary table comprises hinges on the left side of said auxiliary table that allow the left side of the auxiliary table to be hingedly secured to said catherization table;
said auxiliary table comprises vertical lead screen and flexible vertical lead blinds placed above and below the auxiliary table about 2/7 of the way into the auxiliary table from the left side of the auxiliary table and extending out of the front of the auxiliary table;
wherein said vertical lead screen is made of transparent lead plexiglass;
wherein said vertical lead screen has two panels: a first panel of the vertical lead screen placed above the auxiliary table and a second panel of the vertical lead screen that extends out of the front of the auxiliary table;
wherein a hinge is placed between the two panels of the vertical lead screen to allow the second panel to fold and to swing;
wherein the first panel has in its center bottom a cutout that is an about 6 inch to about 6.5 inch semicircle;
wherein a rod is placed vertically in the first panel of the vertical lead screen at the back of the auxiliary table; wherein the hinge and the rod allow the panels of the vertical lead screen to be lifted and folded down flat for storage;
wherein said flexible vertical lead blinds are placed below the two panels of vertical lead screen;
wherein the flexible vertical lead blinds are vertical flexible opaque lead leaves, each leaf about 4-6 inches wide;
wherein the flexible vertical lead blinds are two panels, each panel having a number of leaves; wherein a first panel of blinds is placed below the first panel of lead screen and a second panel of blinds is placed below the second panel of lead screen;
wherein a hinge is located between the two panels of blinds, allowing the two panels of blinds to fold and to swing;
wherein on the right side of the auxiliary table, lead counter weight equal in weight to the weight of the vertical lead screen and vertical lead blinds combined is placed just below the tabletop on the end of the right side of the auxiliary table;
said auxiliary table comprises a rod or a fixed T-shaped rail that runs along the length of the back of the auxiliary table; wherein an IV fluid pole is latched onto the rod or fixed T-shaped rail;
said auxiliary table comprises a tabletop and a storage shelf below the tabletop;
wherein the tabletop is at the top of the table and runs the length and the width of the table and the storage shelf is placed below the tabletop and above the floor by about 12 inches; but it does not run the full length or width of the table;
wherein the storage shelf is recessed with respect to the front of the auxiliary table, so as to allow a user to put his legs underneath the auxiliary table when the auxiliary table is used in a procedure and the user is seated at a stool in front of the auxiliary table;
wherein the storage shelf only extends in length to where the vertical lead blinds and lead screens are placed;
wherein auxiliary table comprises 4 legs: the two legs on the right side being placed just beneath the end of the right side of the auxiliary table; the two legs on the left side are placed just to the right of the lead screens and lead blinds—they are not placed on the left end of the table, but are placed about 2 feet to the right of the left end of the auxiliary table; wherein each leg has at its bottom end a wheel.

2. The auxiliary table of claim 1, wherein the rod or the fixed T-shaped rail is a grooved T-shaped rail about 1″ to about 2″ thick running along the entire length of the back of the auxiliary table; wherein the T-shaped rail is a total of about 2-3″ in width, with two about 1-1.5 inches sections—an about 1-1.5 inches section that is the vertical part of the T and an about 1-1.5 inches section that is the horizontal line of the T.

3. The auxiliary table of claim 1 or claim 2, wherein the tabletop is further covered by rubberized material.

4. A system for performing a catheter-based vascular procedure, comprising: an auxiliary table of any one of claim 1-3 and a catherization table, wherein said auxiliary table is placed at right angle to a catherization table near the top of the catherization table where the patient's head lies so as to allow for full- out extension of the patient's abducted left arm on the auxiliary table; wherein the auxiliary table is hingedly connected to the catherization table.

5. The system of claim 4, further comprising a stool for the operator to sit on, which stool being placed in front of the auxiliary table.

6. A method for performing a catheter based vascular procedure, comprising: placing a patient's abducted left arm in a full-out extension on an auxiliary table of any one of claims 1-3 placed at right angle to a catherization table, near the top of the catherization table where the patient's head lies; wherein said auxiliary table being hingedly secured to said catherization table; wherein placement of all control panels being on the left side of the catherization table in easy reach of an operator's left hand;
having an operator perform the catheter based vascular procedure.

7. The auxiliary table of claim 2, wherein the tabletop is further covered by rubberized material.
